(19) United States
(12) Patent Application Publication
(10) Pub. No.: US 2024/0221133 A1
(43) Pub. Date: Jul. 4, 2024

(54) VARIABLE-SIZED PIXEL GROUPINGS AND BUFFER MANAGEMENT FOR PROCESSING DISTORTED IMAGE DATA

(71) Applicant: TEXAS INSTRUMENTS INCORPORATED, Dallas, TX (US)

(72) Inventors: Niraj Nandan, Plano, TX (US); Rajasekhar Allu, Plano, TX (US); Mihir Narenda Mody, Bangalore (IN); Ankur Ankur, Bangalore (IN); Pandy Kalimuthu, Plano, TX (US)

(21) Appl. No.: 18/148,244

(22) Filed: Dec. 29, 2022

(51) Int. Cl. G06T 5/00; G06T 1/60

(52) U.S. Cl. CPC G06T 5/006; G06T 1/60

(57) ABSTRACT

Various embodiments disclosed herein relate to distorted pixel correction, and more specifically to producing an output image using variable-sized groupings of lines of pixels of an input image. An example embodiment includes a method of using variable-sized pixel groupings when processing distorted image data. The method comprises identifying a context of an image captured by an imaging system, wherein the image comprises lines of pixels that form a distorted representation of a scene, identifying, based on the context of the image, a mapping of variable-sized groupings of the lines to memory ranges in a buffer, wherein an image processing subsystem produces block rows of an output image based on the mapping, and wherein a size of each of the variable-sized groupings varies based on how many of the lines the image processing subsystem uses to produce each of the block rows, and supplying the mapping to the image processing subsystem.

### RELATED APPLICATIONS

This application hereby claims the benefit and priority to U.S. Provisional Application No. 63/347,686 titled “FLEXCONNECT: DYNAMIC THRESHOLDING,” filed Jun. 1, 2022, which is hereby incorporated by reference in its entirety.

### TECHNICAL FIELD

This relates generally to distorted pixel correction, and more particularly, to processing pixel data based on a memory mapping.

### BACKGROUND

Imaging systems and sensors, such as camera-based systems, capture images of a scene (e.g., a landscape, scenery). Camera-based systems can use a variety of lenses, such as wide-angle lenses, fisheye lenses, standard lenses, telephoto lenses, and the like, that can each impact the representation of a captured scene. For example, wide-angle lenses capture larger, wider landscapes in images, however, in doing so, the lens produces distorted representations that often need to be corrected for accuracy and refinement. In addition to lens properties, the perspective or angle at which an imaging system captures a scene can also affect the representation of the scene. Accordingly, image processors may account for the perspective of a scene in an image when employing correction processes.

Traditional image signal processing (ISP) techniques can be employed to process images and correct such distortion. For instance, image processors can use de-warping engines, lens distortion correction engines, and the like to rearrange pixels in the image to represent the scene in an undistorted manner. To perform distortion correction, image processing systems utilize system-wide memory to store image and pixel data, and each component of the image processing system can communicate with the memory to read and write from/to. However, such memory can be widely used by other components and subsystems causing latency in image signal processing steps. Furthermore, various components within the image processing system may reserve more space in the memory than necessary, which can increase latency and reduce overall capacity of the memory for use elsewhere.

### SUMMARY

Disclosed herein are improvements to distorted pixel correction, and more particularly to mapping variable-sized groupings of lines of pixels of an input image, based on context of the input image, to memory ranges in a local memory and processing the variable-sized groupings of pixels from the memory ranges via a perspective transformation engine. An example embodiment includes a method of using variable-sized pixel groupings when processing distorted image data. The method comprises identifying a context of an image captured by an imaging system, wherein the image comprises lines of pixels that form a distorted representation of a scene, identifying, based on the context of the image, a mapping of variable-sized groupings of the lines to memory ranges in a buffer, wherein an image processing subsystem produces block rows of an output image based on the mapping, and wherein a size of each of the variable-sized groupings varies based on how many of the lines the image processing subsystem uses to produce each of the block rows, and supplying the mapping to the image processing subsystem.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter

### BRIEF DESCRIPTION OF THE DRAWINGS

FIG. 1 illustrates an example system for performing distortion correction according to a memory map with variably sized pixel groupings.

FIG. 2 illustrates a series of steps for identifying variable-sized groupings of lines of pixels in an image to be used for distortion correction processes.

FIG. 3 illustrates an example operating environment for performing distortion correction processes using a dynamic memory map.

FIG. 4 illustrates an example process flow demonstrating the creation and use of a dynamic memory map in distortion correction processes.

FIG. 5 illustrates an example representation of mapping portions of an input image to portions of an output image.

FIG. 6 illustrates an example process flow for determining sizes of variable-sized groupings of lines of an input image and corresponding block rows of an output image.

FIGS. 7A and 7B illustrate an example memory map used in an embodiment.

FIG. 8 illustrates an example graphical representation of selecting portions of an input image to create a memory map.

FIG. 9 illustrates an example operating environment for processing multiple types of pixel data in distortion correction processes.

The drawings are not necessarily drawn to scale. In the drawings, like reference numerals designate corresponding parts throughout the several views. In some embodiments, components or operations may be separated into different blocks or may be combined into a single block.

### DETAILED DESCRIPTION

Discussed herein are enhanced components, techniques, and systems related to correcting distorted image data. Imaging systems can produce distorted image data (e.g., deformed pixels, unnaturally curved representations) based on a variety of factors. For example, such distortion can occur based on the angle or focal point at which the image is captured, the lens type or quality used to capture the image, and/or the distance from which the image is captured. Distortion that exists in image data may require users to employ distortion correction or perspective transformation methods to ensure that the image is represented accurately and without distortion. While image signal processing can correct distortion, existing methods do not dynamically allocate buffer space when processing image data and correcting distortion, among other pre-processing activities. Advantageously, apparatuses, devices, systems, and the like herein can support image processing and distortion correction using variably sized groupings of pixels that allow such image processing components to process image data without communicating with system memory at every step of the process. The sizes of the variably sized groupings of pixels can be determined based on properties of an input image and/or the imaging system that captured the input image. In this way, different variably sized groupings of pixels can be mapped to locations in memory on a per image basis or on a per imaging system basis for processing and correction of the images. Accordingly, the improvements and methods described herein provide reliable and efficient ways to write and read distorted image data to and from memory while reducing the capacity required of both system memory and local memory.

One example includes a method of using variably sized pixel groupings when processing distorted image data. The method comprises identifying a context of an image captured by an imaging system, wherein the image comprises lines of pixels that form a distorted representation of a scene, identifying, based on the context of the image, a mapping of variable-sized groupings of the lines to memory ranges in a buffer, wherein an image processing subsystem produces block rows of an output image based on the mapping, and wherein a size of each of the variable-sized groupings varies based on how many of the lines the image processing subsystem uses to produce each of the block rows, and supplying the mapping to the image processing subsystem.

In another example, one or more computer-readable storage media having program instructions stored thereon for mapping image data to memory ranges of a buffer is provided. The program instructions, when read and executed by a processing system, direct the processing system to identify a context of an image captured by an imaging system, wherein the image comprises lines of pixels that form a distorted representation of a scene, identify, based on the context of the image, a mapping of variable-sized groupings of the lines to the memory ranges in the buffer, wherein an image processing subsystem produces block rows of an output image based on the mapping, and wherein a size of each of the variable-sized groupings varies based on how many of the lines the image processing subsystem uses to produce each of the block rows, and supplying the mapping to the image processing subsystem.

In yet another embodiment, a system comprising a processor in communication with an imaging processing subsystem and the imaging processing subsystem comprising a pre-processing component and a lens distortion correction component is provided. The processor is configured to identify a context of an image captured by an imaging system, wherein the image comprises lines of pixels that form a distorted representation of a scene, identify, based on the context of the image, a mapping of variable-sized groupings of the lines to memory ranges in a buffer, wherein a size of each of the variable-sized groupings varies based on how many of the lines the image processing subsystem uses to produce each of the block rows of an output image, and supply the mapping to the image processing subsystem. The image processing subsystem is configured to receive the mapping from the processor, instruct the pre-processing component to write the variable-sized groupings of the image to corresponding ones of the memory ranges in the buffer, and instruct the lens distortion correction component to read the variable-sized groupings from the corresponding ones of the memory ranges to produce corresponding block rows of the output image.

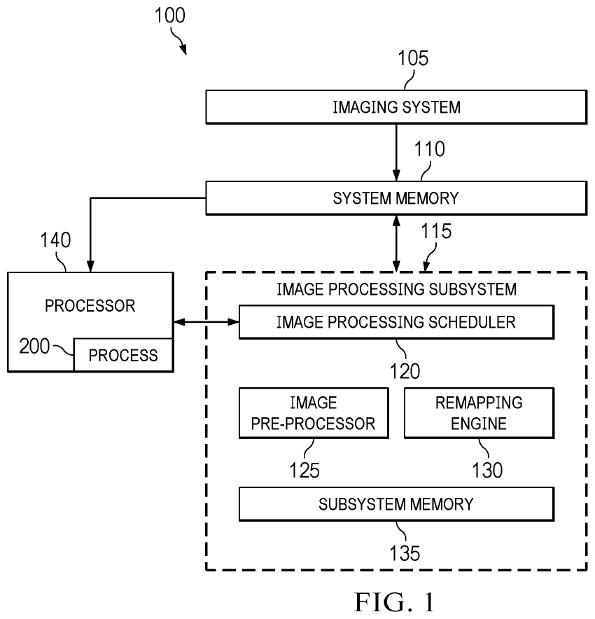

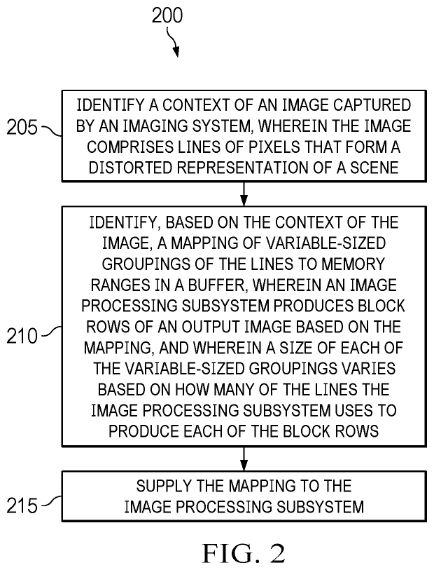

FIG. 1 illustrates an example system for performing distortion correction according to a memory map with variably sized pixel groupings. FIG. 1 shows system 100, which further includes imaging system 105, system memory 110, image processing subsystem 115, and processor 140. Image processing subsystem 115 includes image processing scheduler 120, image pre-processor 125, remapping engine 130, and subsystem memory 135. Image processing subsystem 115 can be configured to receive a memory mapping from processor 140 and process pixel data captured by imaging system 105 according to the memory mapping. Processor 140 can perform memory mapping processes, such as process 200 of FIG. 2.

In operation, imaging system 105 is configured to capture image data representative of a scene (e.g., a landscape, scenery). Imaging system 105 may be a camera, one or more image sensors, a camera-based driver monitoring system (DMS), a camera-based occupant monitoring system (OMS), or the like, capable of producing images, videos, or frames thereof, of the scene. The image data captured by imaging system 105 includes a plurality of pixels in an arrangement (e.g., lines of pixels) that form the representation of the scene. A variety of factors (also referred to herein as context) can impact the representation of the scene, such as properties of a lens used to capture the image (e.g., a type of lens, a curvature of the lens, a quality of the lens), a perspective of imaging system 105 during image capture (e.g., a capture angle, a point of view of imaging system 105, a distance or height of capture with respect to the scene, a focal point), a viewing perspective of the image (i.e., a user-selected perspective of the image), and a resolution of the captured image, among other factors. In an example, imaging system 105 can use a wide-angle lens to capture the image. Often, wide-angle lenses produce images having pixels that form a distorted representation of a scene. A scene may appear distorted when pixels arrange in unnatural ways causing the scene to look warped or curved. To fix the distortion, imaging system 105 can provide the image data to image processing subsystem 115 for correction.

Image processing subsystem 115 interfaces with system memory 110 to obtain the raw image data captured by imaging system 105. Image processing subsystem 115 includes image processing scheduler 120, image pre-processor 125, remapping engine 130, and subsystem memory 135, which together, function to perform various image signal processing (ISP) techniques, such as distortion correction, on the image data obtained from system memory 110. In various examples, image processing subsystem 115 stores the image data obtained from system memory 110 on subsystem memory 135 to avoid interfacing and communicating with system memory 110 at each step during ISP processes. Advantageously, by utilizing subsystem memory 135, image processing subsystem 115 can reduce the amount of memory required of system memory 110 to perform processes of image processing subsystem 115 and increase the available bandwidth of system memory 110 for use by other subsystems (not shown).

Processor 140 also interfaces with system memory 110 to obtain the image data captured by imaging system 105. However, in some cases, processor 140 can obtain the image data directly from subsystem memory 135. Processor 140 is first configured to identify a context of the image captured by imaging system 105. In various instances, context refers the aforementioned factors that affect the scene representation: properties of the lens that captured the image, perspective of imaging system 105 during image capture, distance or height of capture with respect to the scene, focal point of imaging system 105, and resolution of the captured image, among other factors. Processor 140 may determine the context from the image (i.e., via properties/characteristics of the image data) or imaging system 105 (i.e., via attributes of imaging system 105). Alternatively, imaging system 105 can provide the context to processor 140. Regardless, processor 140 can identify information like the pixel arrangement and the density of the lines of pixels in the image based on the context. Following the previous example of using a wide-angle lens, processor 140 may recognize that the pixels are more distorted along the outer portions of the image than other portions given the fisheye-type representation produced by the wide-angle lens. In such cases, the pixels may be densely arranged in distorted regions of the representation.

Next, processor 140 identifies, based on the context of the image, a mapping (e.g., an arrangement within a memory-mapped register (MMR)) of variable-sized groupings of the lines (which may include sets of two-dimensional blocks) to memory ranges (e.g., a set/range of addresses or locations in a memory) in a subsystem memory 135. Image processing subsystem 115 can use the mapping to produce an output image that includes pixels in a different arrangement (than the image captured by imaging system 105) that form an undistorted representation of the scene. The output image can be formed using rows of blocks (also referred to herein as block rows) that may be generated by processing the variable-sized groupings of the lines of pixels from the input image. The block rows include groupings of lines of pixels whereby a height of a block row is equal to the number of lines of pixels in the block row. The blocks that make up the block rows are organized horizontally within the block row and each have a smaller width than the block rows themselves. Thus, the mapping can identify, for each block row of the output image, a corresponding grouping of lines from the input image and the memory range in subsystem memory 135 holding the data for the grouping of lines.

Processor 140 can identify a different number of lines for each grouping. The size (i.e., number of lines per grouping) of each grouping can vary based on how many lines image processing subsystem 115 uses to produce each of the block rows. Following the previous example using a wide-angle lens, processor 140 may group fewer lines of pixels together along the outer portions of the image, given the amount of distortion and, consequently, higher pixel density, and processor 140 may group many lines of pixels together throughout other portions of the image having less distortion/pixel density. Other types of lenses or perspectives can require use of a different mapping including different sized and combinations of lines. In some cases, processor 140 also determines the size of a grouping based on available capacity of subsystem memory 135.

Processor 140 can map each grouping to a memory range based on the size of the grouping. For example, processor 140 can map a large grouping (i.e., a grouping including many lines of pixels) to a wide memory range, while it can map a smaller grouping, with respect to the large grouping, to a smaller memory range. In addition to mapping groupings to memory ranges, processor 140 can map portions (e.g., blocks and/or row(s) of blocks) of the output image to corresponding memory ranges in subsystem memory 135.

In various examples, subsystem memory 135 is a circular buffer of a fixed size/capacity determined based on the sizes of the groupings of lines. The memory addresses of subsystem memory 135 can be written to/read from and overwritten after data is read from the addresses. By way of example, processor 140 can map a grouping of lines to a range of addresses, a different grouping of lines to another range of addresses, and a further grouping of lines to a further range of addresses or to a previously used range of addresses once the image data in the range has been read. In another example, subsystem memory 135 may include one memory with allocated capacity or addresses assigned for distortion correction processes described herein. In yet another example, subsystem memory 135 can include two or more memories. Any variation or combination of groupings to memory ranges and types or quantities of memories can be contemplated.

Then, processor 140 supplies the mapping to image processing subsystem 115 so that components of imaging processing subsystem 115 can perform ISP techniques according to the mapping. Image processing scheduler 120 can be configured to receive the mapping. Image processing scheduler 120 may be a hardware thread scheduler that directs use of subsystem memory 135. For example, image processing scheduler 120 can configure components of image processing subsystem 115 to operate according to the mapping. First, image processing scheduler 120 instructs image pre-processor 125 to begin writing data of one or more groupings of lines of the image data to a portion (e.g., a set/range of addresses) of subsystem memory 135. Image pre-processor 125 represents an image pipeline component (e.g., a vision imaging subsystem) configured to perform pre-processing tasks on the image data, such as converting raw pixel data into processed pixel data. After image pre-processor 125 writes the grouping(s) into memory ranges of subsystem memory 135, image processing scheduler 120 can instruct remapping engine 130 to read the image data from the memory ranges into one or more blocks or block rows of the output image according to the mapping. Remapping engine 130 represents a component configured to correct distortion in the image by processing the image data from the input image and producing the output image to form an undistorted representation of the scene. Examples of remapping engine 130 include a lens distortion corrector, a de-warping engine, and a perspective transformation engine, among other components.

In various cases, image processing scheduler 120 instructs the image pre-processor 125 and the remapping engine 130 to operate on a per block row basis. In other words, image processing scheduler 120 provides image pre-processor 125 with a command to write data of grouping(s) of lines required to populate corresponding blocks of a block row in the output image. After writing some or all of the data of the grouping(s), image processing scheduler 120 can provide remapping engine 130 with a command to read the data of the grouping(s) from subsystem memory 135 to process and produce the blocks of the block row. This process may repeat for any number of block rows in the output image, according to the mapping, until the output image is reconstructed with pixel data in an arrangement that forms the undistorted representation of the scene.

Still referring to FIG. 1, image processing scheduler 120, image pre-processor 125, and remapping engine 130 are representative of fixed-purpose hardware components capable of implementing the distortion correction processes described herein. Examples of these components include integrated circuits (ICs), application specific integrated circuits (ASICs), logic devices, and other such circuitry, as well as any combination or variation thereof. Alternatively, the components of image processing subsystem 115 may be implemented as general purpose hardware, such as a microprocessor, capable of executing software and/or firmware that embodies the logic of the distortion correction processes disclosed herein.

Processor 140 is representative of any processing device capable of determining a memory map for image processing activities described here. Examples of processor 140 include a microprocessor, a central processing unit (CPU), one or more processing cores, a microcontroller unit (MCU), and/or other processing devices and circuitry capable of executing instructions, logic, and/or software and firmware that embodies the techniques of mapping for image processing disclosed herein. Processor 140 may be implemented within a single processing device, but it may also be distributed across multiple processing devices or subsystems that cooperate in executing instructions.

Subsystem memory 135 may comprise any computer-readable storage media capable of being read and written to by image pre-processor 125 and read from by remapping engine 130, among other components of system 100. Subsystem memory 135 may include volatile and nonvolatile, removable and non-removable media implemented in any method of technology for storage of information. As mentioned, subsystem memory 135 may be a circular buffer, or two or more circular buffers. However, other types of buffers or memories of various sizes/capacities can be used. Likewise, system memory 110 may also comprise any computer-readable storage media capable of being read and written to by imaging system 105, image processing subsystem 115, and other components of system 100. System memory 110 may include volatile and nonvolatile, removable and non-removable media implemented in any method of technology for storage of information. Subsystem memory 135 may be implemented separately from system memory 110, but it may also be implemented in an integrated manner with respect to system memory 110.

Moving to FIG. 2. FIG. 2 illustrates a series of steps for identifying variable-sized groupings of lines of pixels in an image to be used for distortion correction processes. FIG. 2 includes process 200 described parenthetically below, which references elements of FIG. 1. Process 200 can be implemented on fixed-purpose, dedicated hardware, software, or any combination or variation thereof. For example, process 200 can be performed by processor 140 of FIG. 1.

In operation 205, processor 140 identifies (205) a context of an image captured by imaging system 105, wherein the image comprises lines of pixels that form a distorted representation of a scene. Imaging system 105 may be a camera, one or more image sensors, a camera-based driver monitoring system (DMS), a camera-based occupant monitoring system (OMS), or the like, capable of producing images, videos, or frames thereof, of the scene. In various instances, context can refer to properties of a lens used to capture the image (e.g., a type of lens, a curvature of the lens, a quality of the lens), a perspective of imaging system 105 during image capture (e.g., a capture angle, a point of view of imaging system 105, a distance or height of capture with respect to the scene, a focal point), a viewing perspective of the image (i.e., a user-selected perspective of the image), and a resolution of the captured image, among other factors. Based on the context of the image, the lines of pixels can form an arrangement causing the scene to appear distorted (e.g., warped, curved). For example, pixels captured using a wide-angle lens may be distorted along the outer portions of the image because the wide-angle lens captures fisheye-type representations of scenes. Processor 140 may determine the context from the image (i.e., via properties or characteristics of the image data), or imaging system 105 can provide the context to processor 140. Regardless, processor 140 can identify information like the arrangement and the density of the lines of pixels in the image based on the context.

Next, in operation 210, processor 140 identifies (210), based on the context of the image, a mapping of variable-sized groupings of the lines (which may include sets of two-dimensional blocks) to memory ranges in a subsystem memory 135 (e.g., a buffer). Image processing subsystem 115 can use the mapping to produce an output image that includes pixels in a different arrangement (than the image captured by imaging system 105) that form an undistorted representation of the scene. The output image can be formed using rows of blocks (also referred to herein as block rows) that may be generated by processing the variable-sized groupings of the lines of pixels from the input image. The block rows include groupings of lines of pixels whereby a height of a block row is equal to the number of lines of pixels in the block row. The blocks that make up the block rows are organized horizontally within the block row and each have a smaller width than the block rows themselves. Thus, the mapping can identify, for each block row of the output image, a corresponding grouping of lines from the input image and the memory range in subsystem memory 135 holding the data for the grouping of lines.

Processor 140 can identify a different number of lines for each grouping. The size (i.e., number of lines per grouping) of each grouping can vary based on how many lines image processing subsystem 115 uses to produce each of the block rows. Following the previous example using a wide-angle lens, processor 140 may group fewer lines of pixels together along the outer portions of the image, given the amount of distortion and, consequently, higher pixel density, and processor 140 may group many lines of pixels together throughout other portions of the image having less distortion/pixel density. In some cases, processor 140 also determines the size of a grouping based on available capacity of subsystem memory 135.

Then, processor 140 maps or assigns the variable-sized groupings to memory ranges in subsystem memory 135. Processor 140 can map each grouping to a memory range based on the size of the grouping. For example, processor 140 can map a large grouping (i.e., a grouping including many lines of pixels) to a wide memory range, while it can map a smaller grouping, with respect to the large grouping, to a smaller memory range. In addition to mapping groupings to memory ranges, processor 140 can map portions (e.g., blocks and/or row(s) of blocks) of the output image to corresponding memory ranges in subsystem memory 135.

Lastly, in operation 215, processor 140 supplies (220) the mapping to image processing subsystem 115. Image processing subsystem 115 include image processing scheduler 120, image pre-processor 125, remapping engine 130, and subsystem memory 135. Image processing scheduler 120 can be configured to receive the mapping from processor 140 and direct use of subsystem memory 135 per the mapping. First, image processing scheduler 120 instructs image pre-processor 125 to write data of one or more groupings of lines of the image data to one or more memory ranges of subsystem memory 135. Image pre-processor 125 represents an image pipeline component configured to perform pre-processing tasks on the image data, such as converting raw pixel data into processed pixel data. After image pre-processor 125 writes the groupings to subsystem memory 135, image processing scheduler 120 can instruct remapping engine 130 to read the image data from the memory ranges of subsystem memory 135. Remapping engine 130 represents a component configured to correct distortion in the image by processing the image data from the input image and producing the output image. Examples of remapping engine 130 include a lens distortion corrector, a de-warping engine, and a perspective transformation engine, among other components.

In various cases, image processing scheduler 120 instructs the image pre-processor 125 and the remapping engine 130 to operate on a per block row basis according to the mapping. In other words, image processing scheduler 120 provides image pre-processor 125 with a command to write data of grouping(s) of lines required to populate corresponding blocks of a block row in the output image. After writing some or all of the data of the grouping(s), image processing scheduler 120 can provide remapping engine 130 with a command to read the data of the grouping(s) from subsystem memory 135 to process and produce the blocks of the block row. This process may repeat for any number of block rows in the output image, according to the mapping, until the output image is reconstructed with pixel data in an arrangement that forms the undistorted representation of the scene.

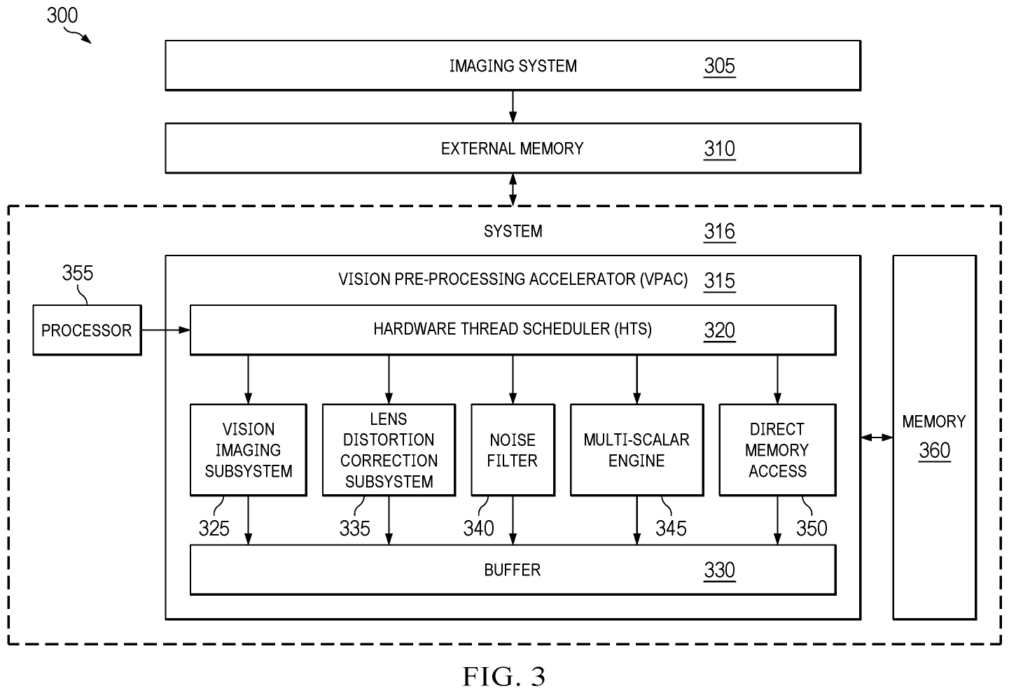

FIG. 3 illustrates an example operating environment for performing distortion correction processes using a dynamic memory map. FIG. 3 shows operating environment 300, which includes imaging system 305, external memory 310, and system 316. System 316 further includes vision pre-processing accelerator (VPAC) 315, processor 355, and memory 360. VPAC 315 further includes hardware thread scheduler (HTS) 320, vision imaging subsystem (VISS) 325, buffer 330, lens distortion correction (LDC) subsystem 335, noise filter 340, multi-scalar engine 345, and direct memory access 350. Processor 355 is configured to generate a memory mapping that identifies portions of pixel data and corresponding memory ranges of buffer 330. VPAC 315 is configured to receive the memory mapping from processor 355 and instruct components of VPAC 315 to operate according to the memory mapping.

In operation, imaging system 305 is configured to capture or receive image data representative of a scene. Imaging system 305 may be a camera, one or more image sensors, or the like, capable of producing an image of the scene. The image data captured by imaging system 305 includes a plurality of pixels arranged in lines that form the representation of the scene. The context in/by which imaging system 305 captures the image can impact the representation of the scene. For example, context can refer to properties of a lens used to capture the image (e.g., a type of lens, a curvature of the lens, a quality of the lens), a perspective of imaging system 105 during image capture (e.g., a capture angle, a point of view of imaging system 105, a distance or height of capture with respect to the scene, a focal point), a viewing perspective of the image (i.e., a user-selected perspective of the image), and a resolution of the captured image, among other factors. For example, if imaging system 305 uses a wide-angle lens to capture the image, imaging system 305 can produce a distorted representation of the scene because wide-angle lenses often cause pixels to arrange in curved and warped ways.

Imaging system 305 provides the raw image data to external memory 310 (e.g., double data rate (DDR)). In many scenarios, external memory 310 is used by system 316 and several other components and subsystems (not shown in operating environment 300). Thus, it may be advantageous to minimize traffic between system 316 and external memory 310 to reduce latency of image processing, among other things. System 316, representative of a system-on-chip (SoC) capable of processing images and image data, interfaces with external memory 310 to obtain the raw image data captured by imaging system 305 and stores the image data on a memory of system 316 to avoid interfacing with external memory 310 at each step of image processing and correction.

Processor 355 can obtain the image data captured by imaging system 105 from a memory. Processor 355 is first configured to identify the context of the image captured by imaging system 305. Processor 355 may determine the context from the image or imaging system 305, or imaging system 305 can provide the context to processor 140. Regardless, processor 355 can identify information like the pixel arrangement and the density of the lines of pixels in the image based on the context. In examples where imaging system 305 uses a wide-angle lens, processor 355 may recognize that the pixels are more distorted along the outer portions of the image than other portions given the fisheye-type representation produced by the wide-angle lens. In such cases, the pixels may be densely arranged in distorted regions of the representation.

Next, processor 355 identifies, based on the context of the image, a mapping of variable-sized groupings of the lines to memory ranges in a buffer 330 (e.g., a circular buffer) or memory 360. VPAC 315 can use the mapping to produce an output image that includes pixels in a different arrangement (than the image captured by imaging system 305) that form an undistorted representation of the scene. The output image can be a different size and dimension than the input image and can be formed using rows of blocks that may be generated by processing the variable-sized groupings of the lines of pixels from the input image. The block rows include groupings of lines of pixels whereby a height of a block row is equal to the number of lines of pixels in the block row. The blocks that make up the block rows are organized horizontally within the block row and each have a smaller width than the block rows themselves. Thus, the mapping can identify, for each block row of the output image, a corresponding grouping of lines from the input image and the memory range holding the data for the grouping of lines.

Processor 355 can identify a different number of lines for each grouping. The size of each grouping can vary based on how many lines VPAC 315, or more specifically, LDC subsystem 335, uses to produce each of the block rows. Following the previous example using a wide-angle lens, processor 355 may group fewer lines of pixels together along the outer portions of the image, given the amount of distortion and, consequently, higher pixel density, and processor 355 may group many lines of pixels together throughout other portions of the image having less distortion/pixel density. In some cases, processor 355 also determines the size of a grouping based on available capacity of buffer 330 or memory 360.

Then, processor 355 maps or assigns the variable-sized groupings to memory ranges in buffer 330. Processor 355 can map each grouping to a memory range based on the size of the grouping. For example, processor 355 can map a large grouping (i.e., a grouping including many lines of pixels) to a wide memory range, while it can map a smaller grouping, with respect to the large grouping, to a smaller memory range. In addition to mapping groupings to memory ranges, processor 355 can map portions (e.g., blocks and/or row(s) of blocks) of the output image to corresponding memory ranges in buffer 330.

Buffer 330 may have a fixed size/capacity determined based on the sizes of the groupings of lines. The memory addresses of buffer 330 can be written to/read from in a circular nature meaning they can be overwritten after data is read from the addresses. By way of example, processor 355 can map a grouping of lines to a range of addresses, a different grouping of lines to another range of addresses, and a further grouping of lines to a further range of addresses or to a previously used range of addresses once the image data in the range has been read. Any variation or combination of groupings to memory ranges can be contemplated.

Then, processor 355 supplies the mapping to VPAC 315 to perform ISP techniques according to the mapping. HTS 320 can be configured to receive the mapping and to direct the use of buffer 330 by components of VPAC 315 based on the mapping. For instance, HTS 320 can instruct VISS 325 to write image data of one or more groupings of lines to one or more memory ranges of buffer 330. VISS 325 represents an image pipeline component configured to perform pre-processing tasks on the image data, such as converting raw pixel data into processed pixel data. For example, VISS 325 is an example of an image pre-processing component, such as image pre-processor 125 of FIG. 1. After VISS 325 writes the grouping(s) into corresponding memory ranges, HTS 320 can instruct LDC subsystem 335 to read the image data from the memory ranges to process and produce one or more blocks of the output image according to the mapping. LDC subsystem 335 represents a subsystem configured to correct distortion in the image by processing the image data and producing the output image. For example, LDC subsystem 335 is an example of a remapping engine, such as remapping engine 130 of FIG. 1.

In various examples, HTS 320 sends instructions to VISS 325 and LDC subsystem 335 on a per block row basis. In other words, HTS 320 provides VISS 325 with a command to write data of grouping(s) of lines, required to process corresponding block(s) of a block row in the output image, to buffer 330. After writing some or all of the data of the grouping(s), HTS 320 can instruct direct memory access 350 to move and/or copy the data from buffer 330 to memory 360. Then, HTS 320 can provide LDC subsystem 335 with a command to read the data from memory 360 to process and produce blocks of a block row in the output image using the data. After LDC subsystem 335 consumes the data for the block(s), or the entirety of the block row, HTS 320 can once again provide VISS 325 with a write command to write data of different grouping(s) to buffer 330. This process can repeat until VISS 325 writes all necessary data of the input image and LDC subsystem 335 reads the data and generates the output image with corrected image data. In this way, VISS 325 can overwrite data in buffer 330, and the data in memory 360 can be used downstream and/or by components of VPAC 315 and/or system 316. In other embodiments, memory 360 and buffer 330 may be included in an integrated fashion, such as in a single memory (e.g., only via buffer 330) wherein the memory ranges allocated to VISS 325 and LDC subsystem 335, for example, are portions (e.g., locations/addresses or ranges thereof) of memory within the single memory. In such an embodiment, direct memory access 350 can be configured to move and/or copy data from a portion of memory to a different portion in the memory. Additionally, other combinations and variations of types, locations, and hierarchies of memory can be contemplated.

Following distortion correction processes, VPAC 315 can be configured to provide the corrected image pixel data to external memory 310 for downstream use. Other components of VPAC 315 can also use the corrected image pixel data for other ISP techniques. For example, noise filter 340, multi-scalar engine 345, and direct memory access 350 can access the corrected image pixel data from buffer 330 or memory 360 for respective functions. Noise filter 340 can be configured to perform filtering processes on the pixel data. Multi-scalar engine 345 can be configured to produce differently scaled outputs of the pixel data. And direct memory access 350 can be configured to provide the pixel data to peripherals (e.g., other systems, devices, applications). The positions of each component of VPAC 315 may vary within VPAC 315, and thus, the pixel data can be communicated between components of VPAC 315 in various orders. Alternatively, VPAC 315 may include fewer or additional components than those shown in FIG. 3.

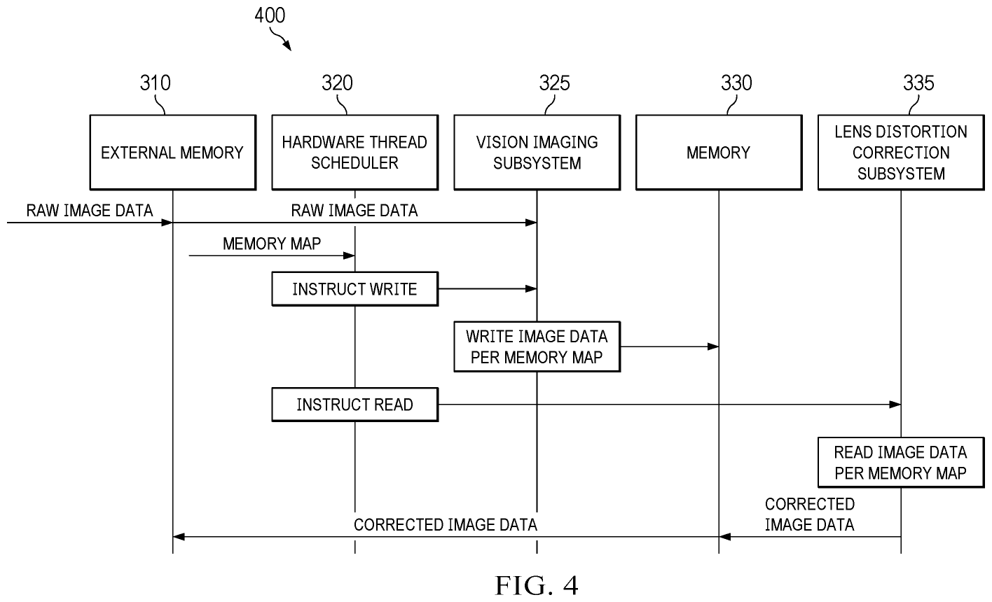

FIG. 4 illustrates an example process flow demonstrating the creation and use of a dynamic memory map in distortion correction processes. FIG. 4 includes operating environment 400, which references elements of FIG. 3. Operating environment 400 includes external memory 310, hardware thread scheduler (HTS) 320, vision imaging subsystem (VISS) 325, buffer 330, and lens distortion correction (LDC) subsystem 335.

First, an imaging system (e.g., imaging system 305; not pictured) can store raw image data on external memory 310. The raw image data includes a plurality of pixels arranged in lines, which form a representation of a scene (e.g., a landscape, scenery). The context in/by which the imaging system captures the image can impact the representation of the scene. For example, context can refer to properties of a lens used to capture the image (e.g., a type of lens, a curvature of the lens, a quality of the lens), a perspective of imaging system 105 during image capture (e.g., a capture angle, a point of view of imaging system 105, a distance or height of capture with respect to the scene, a focal point), a viewing perspective of the image (i.e., a user-selected perspective of the image), and a resolution of the captured image, among other factors. For example, if the imaging system uses a wide-angle lens to capture the image, the imaging system can produce a distorted representation of the scene because wide-angle lenses often cause pixels to arrange in curved and warped ways.

External memory 310 is a system memory configured to store the raw image data and interface with one or more subsystems or components, including any of the components of operating environment 400. For example, system 316 interfaces with external memory 310 to obtain the raw image data captured by imaging system 305. Once VPAC 315, or another component of system 316, obtains the raw image data, processing of the image data can begin. For example, VISS 325 can use the data obtained from external memory 310 to perform various pre-processing operations and store data on buffer 330 so that other components of VPAC 315 can communicate with buffer 330 and avoid interfacing and communicating with external memory 310 at each step during ISP processes.

Next, HTS 320 is configured to receive a memory map from a processing device, such as processor 355. The processing device can be configured to identify the context of the image captured by the imaging system and identify the pixel arrangement and density within the image based on the context. Following the previous example wherein the image is captured using a wide-angle lens, the processing device can determine that the pixels form a distorted representation given the properties or characteristics of the lens, identify the locations within the image where the pixels form heavy distortion, determine how the pixels are arranged, including pixel density and/or overlap in parts of the image, and the like. Then, the processing device can identify groupings of lines of the pixels in the image based on the context of the image. In this example, the processing device can determine that the lines of pixels in the image are heavily distorted along the outer portions of the image and minorly distorted in the middle portions of the image. Accordingly, the processing device may group fewer lines of pixels together along the outer portions, given the amount of distortion and, consequently, higher pixel density, and the processing device may group many lines of pixels together throughout other portions of the image having less distortion/pixel density. The processing device creates the memory map by assigning the groupings of lines to memory ranges in buffer 330. Additionally, the processing device can map block rows of an output image to memory ranges in buffer 330. The output image can be a different size and dimension than the input image and include pixels in a different arrangement that form an undistorted representation of the scene. The output image can be formed using rows of blocks that may be generated by processing subsets of the groupings of pixels from the input image. The block rows include groupings of lines of pixels whereby a height of a block row is equal to the number of lines of pixels in the block row. The blocks that make up the block rows are organized horizontally within the block row and each have a smaller width than the block rows themselves. Thus, the mapping can identify, for each block row of the output image, a grouping of lines from the input image and a memory range in buffer 330 holding the data for the grouping of lines.

HTS 320 receives the memory map and directs the use of buffer 330 to accomplish distortion correction techniques, among other functionality. HTS 320 can first instruct VISS 325 to write data associated with one or more groupings of lines of the image data to buffer 330 based on the memory map. After VISS 325 writes the data to buffer 330, HTS 320 can instruct LDC subsystem 335 to read the data from buffer 330 to process and produce one or more blocks in a block row of the output image according to the memory map. After correcting the representation in the image to an undistorted representation, LDC subsystem 335 provides the corrected image data to buffer 330, memory 360 (not shown), and/or external memory 310 for use downstream.

In some cases, after VISS 325 writes the data to buffer 330, HTS 320 may instruct direct memory access 350 of FIG. 3 (not shown in FIG. 4) to move and/or copy the data from buffer 330 to memory 360 (not shown in FIG. 4). In such cases, HTS 320 may alternatively instruct LDC subsystem 335 to read the data from memory 360 to process and produce the block rows of the output image.

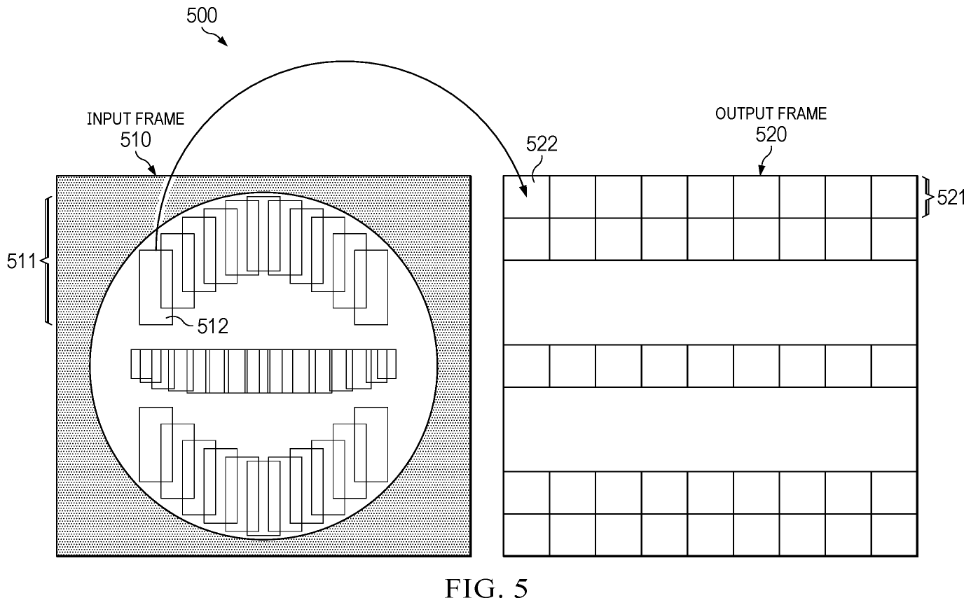

FIG. 5 illustrates an example representation of mapping portions of an input image to portions of an output image. FIG. 5 includes input image 510 and output image 520. Input image 510 can be split into variable-sized line groupings (e.g., line grouping 511) and each line grouping can be divided further into input blocks (e.g., input block 512). The pixel data from each line grouping can be mapped to ranges in memory, which can be referenced to populate data into block rows (e.g., block row 521) of output image 520.

In various examples, an imaging system can capture input image 510 using a camera, image sensor, or the like. Input image 510 includes a plurality of pixels that form a representation of a scene. The context in/by which the imaging system captures input image 510 can impact the representation of the scene. Context can include properties of a lens used to capture the image, a perspective of the image, and a resolution of the captured image, among other factors. In the example illustrated in FIG. 5, the imaging system captures input image 510 using a wide-angle lens. Due to at least the properties of the wide-angle lens, input image 510 forms a curved representation of the scene. Based on this context, the input image 510 can be divided into line groupings where the heaviest distortion exists (e.g., line grouping 511), and each grouping can further be divided into input blocks (e.g., input block 512).

A computing device, such as a microcontroller (MCU), can identify the variable-sized groupings of lines of pixels. Line grouping 511 is an example of a variable-sized grouping that includes a plurality of pixels divided into input blocks of input image 510. The computing device can determine the number of lines of pixels per grouping based on an amount of distortion, pixel density in the section, and a capacity of a local memory, among other considerations. As a result, the computing device can identify a different number of lines for each grouping and for each input block. The lines of pixels within each input block may also be included in other input blocks as well given overlap and/or a need to use such pixels for correction purposes.

The computing device can also identify output image 520 that includes pixels processed and corrected from input image 510 in a different arrangement that forms an undistorted representation of the scene. Output image 520 can be divided into block rows (e.g., block row 521), and each block row can include smaller chunks referred to as blocks (e.g., block 522 of block row 521). Each block in a block row includes a subset of pixels of a grouping of pixels derived from the input image. For example, block 522 can be based on pixel data from some or all of the lines of pixels of input block 512, or it may be based on fewer lines of pixels. After identifying each line grouping, block, and block row, the computing device can generate a mapping that associates line groupings of input image 510 to memory ranges of a local memory and blocks of output image 520 to memory ranges of the local memory. This mapping can be used by one or more image processing components to write pixel data of a line grouping of input image 510 into a corresponding memory range and to read processed pixel data associated with the pixels of the line grouping from the memory range into corresponding block(s) of output image 520.

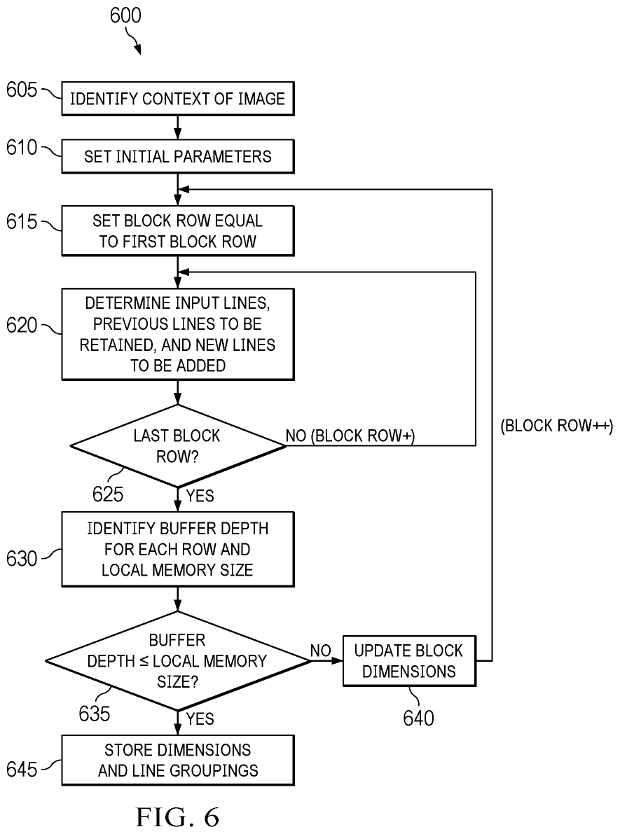

FIG. 6 illustrates an example process flow for determining sizes of variable-sized groupings of lines of an input image and corresponding block rows of an output image. FIG. 6 shows process 600, which may be executed by a computing device or processor, such as processor 140 of FIG. 1 or processor 355 of FIG. 3.

In operation 605, a processor identifies context of an image captured by an imaging system. Context, in many examples, can refer to properties of a lens used to capture the image (e.g., a type of lens, a curvature of the lens, a quality of the lens), a perspective of the imaging system during image capture (e.g., a capture angle, a point of view of imaging system 105, a distance or height of capture with respect to the scene, a focal point), a viewing perspective of the image (i.e., a user-selected perspective of the image), and a resolution of the captured image, among other factors.

In operation 610, the processor can use the context and/or memory capacity to set initial parameters of the output image. For example, the processor can first determine the size of an output image, and portions of the output image, to be used in distortion correction processes. The output image can be a different size and dimension than the input image (i.e., the image captured by the imaging system) and can be made up of a different arrangement of pixels that form an undistorted representation of the scene. The output image is arranged in blocks, and each row of blocks creates a block row. One block row may include multiple blocks of the same size (height and width). The height of the blocks, and consequently, the block row, can be determined by the number of lines of pixels included in a block. In other words, the height of a block, and block row, is equal to the number of lines of pixels, which may be varied and incremented/decremented. The width of each block in a block row can also be selected and incremented or decremented to a desired width. The desired height and width may ultimately allow for efficient processing with minimal memory capacity requirements, for example. In various cases, operation 610 can begin by using initial block dimensions, such as 8 pixels by 8 pixels. After each iteration and determination of buffer depth using the block dimensions, the block height/width can be incremented or decremented until the buffer depth consumed by the blocks, or a block row, fits within memory or processing constraints.

Additionally, the processor can also determine the capacity and availability of a local memory to be used in the distortion correction processes. In various instances, the local memory is a buffer used by image processing pipeline components and a remapping engine, among other components, such as the components of VPAC 315 or system 316 of FIG. 3. The amount of memory allocated to such image processing components may be selected based on the context and/or the determined block size, or it may be a pre-determined fixed amount. The amount of allocated memory may also dictate the size of the blocks of the output image.

Next, in operation 615, the processor determines the block row size based on the size of each block and the number of blocks in the block row, which may be determined from the size of the output frame and the block dimensions. The height of the block row is the same as the height of the blocks in the block row. The width of the block row is determined by the width of the output image. In operation 615, the processor can begin with a first block row and use the size and number of blocks for the block row as determined in operation 610 (or following operation 640).

In operation 620, the processor determines which lines of pixels from the input image can be mapped to the blocks in the first block row. These lines of pixels are also referred to herein as a grouping of lines. First, based on the context identified in operation 605, the processor can identify a grouping of lines of pixels that can be used to reconstruct the undistorted scene in the first block row of the output image. The processor can determine, for the first grouping of lines, the starting and ending locations/coordinates of the lines of pixels within the input image. The processor can repeat this step (operation 625) for each block in a block row and each block row in the output image. For example, for a second block row in the output image, the processor can determine a second grouping of lines of pixels, of a different size from the first grouping of lines, that can be used for the second block row, and for each block within the second block row. This second grouping of lines may include a subset of lines of pixels from the first grouping of lines (e.g., overlapping lines), or it may include different lines of pixels entirely.

For each mapping of a grouping of lines to a block row, the processor can also identify which lines of pixels from a grouping may be used in a subsequent block row (with respect to a current block row). For example, the processor can determine which lines may be retained from a current block row and used in a subsequent block row (i.e., overlapping lines that are used for both the current block row and an immediately subsequent block row) and/or which lines mapped to the subsequent block row differ from the lines of the current block row (i.e., non-overlapping lines of pixels). Based on a number of overlapping lines from one block row to the next, the processor can identify a decrement value corresponding to a number of lines that can be removed from memory when moving from one block row to the next block row during image processing. Additionally, based on the number of newly added lines for the subsequent block row, the processor can determine a look-ahead, or offset, value corresponding to an additional number of lines that can be written to memory during mapping activities for the first block row. In some examples, such determinations of operation 620 will produce a start line and an end line for the set of lines in the input image used to produce the current block row and an end line for the set of lines in the input image used to produce the next block row or some other indication of the look-ahead or offset. The determination of operation 620 may also determine which portions of a memory (e.g., buffer 330 or memory 360 of FIG. 3) are to be used for the set of lines associated with the current block row and the offset.

In operation 630, following the mapping of line groupings to block rows, the processor determines the buffer depth, or capacity required, for each block row and identifies the maximum local memory required to process the block rows. In various examples, the buffer depth required to write data for each block row may vary in size because the number of lines for a block row, look-ahead to support a subsequent block row, and/or the decrement value from a previous block row varies for each block row. The amount of look-ahead, or additional lines, added to a given block row in memory may be based on the context of the image and a capacity of local memory available. While the buffer depth for each block row varies, the processor can determine the maximum memory required by comparing the buffer depths for all block rows. Thus, upon completion of operation 630, the processor has identified the buffer depth, and consequently, the maximum number of lines needed to complete full frame processing of the input image.

In operation 635, the processor compares the buffer depth to the available local memory. In various examples, the processor can set the local memory size (or allocate an amount of local memory) to be greater than the largest buffer depth to ensure the local memory has capacity to store the data of any of the block rows at a given time. However, in cases where the buffer depth exceeds the capacity of the local memory (e.g., if the capacity is fixed), the processor can update (operation 640) the block dimensions of a block row, such that fewer lines of pixels can be mapped to each block, and consequently the entire block row. Accordingly, this may reduce the size of the block row and the buffer depth of the block row. Following an update to the block dimensions of a block row in operation 640, the process can return to operation 615 to continue the algorithm.

Once the buffer depth for processing all the block rows is determined, and the buffer depth does not exceed local memory capacity, the processor, in operation 645, can store the block dimensions, block row dimensions, and the line groupings associated with each block row in a memory map for use by an image processing subsystem (e.g., image processing subsystem 115 of FIG. 1).

Advantageously, the processor can determine the least amount of local memory required to store data during distortion correction processes. The amount of storage required of the local memory can vary for each block row due to the overlap and look-ahead used for each block row. Accordingly, bandwidth of the local memory can be adjusted, and possibly reduced overall, on a per block row basis.

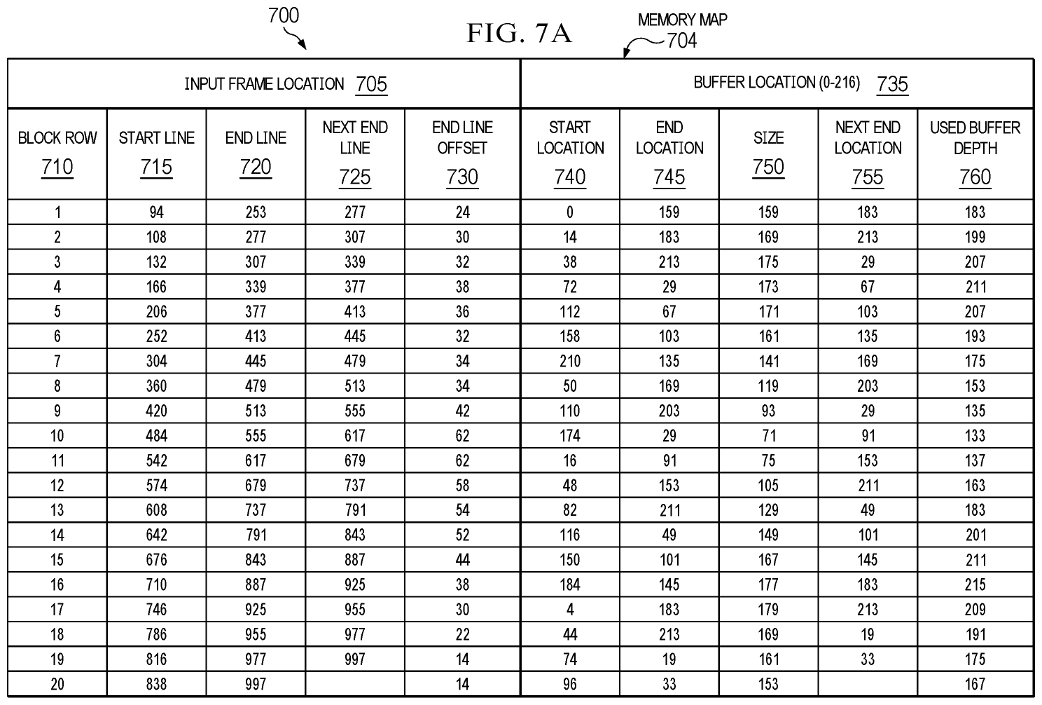

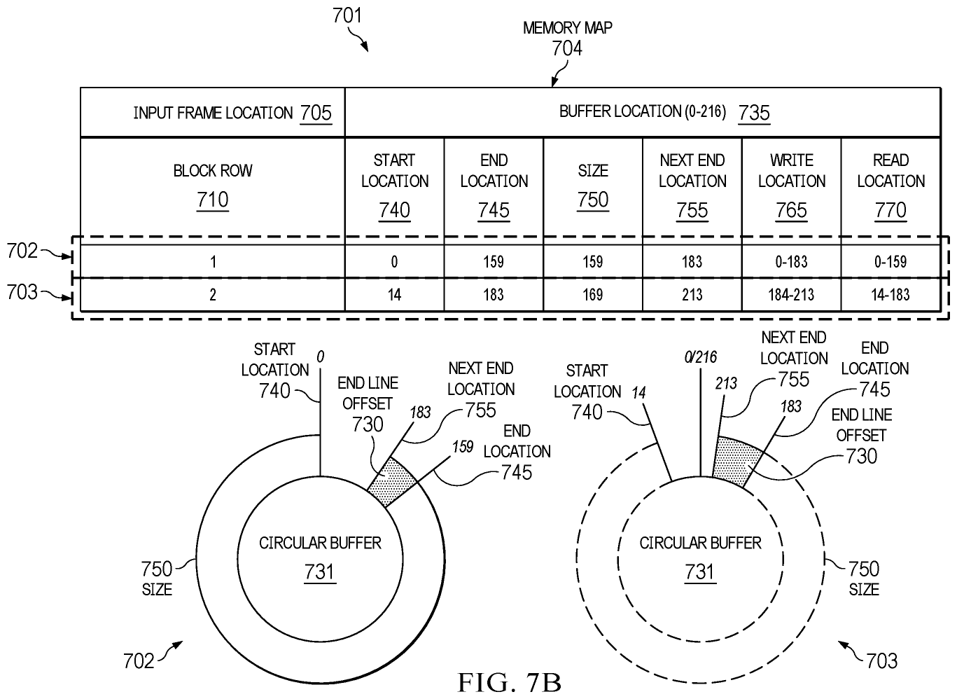

FIGS. 7A and 7B illustrate an example memory map used in an embodiment. FIG. 7A includes aspect 700, which further includes memory map 704. Memory map 704 details mappings of portions of an input location (input image location 705), block rows in an output image (block row 710), and memory ranges in a local memory (buffer location 735). FIG. 7B shows a portion of memory map 704 in aspect 701, and further shows aspects 702 and 703, which depict graphical representations using memory map 704 to populate memory ranges of circular buffer 731.

In operation, a microcontroller unit (MCU), or other computing device, provides memory map 704 to facilitate the functions of image processing and distortion correction components when processing an input image captured by an imaging system. In various examples, the input image includes lines of pixels that form a distorted representation of a scene due to one or more reasons (e.g., properties of a lens used by the imaging system, perspective of the imaging system). To correct the distorted representation, image processing and distortion correction components can write/read lines of pixels according to memory map 704 to rearrange the lines of pixels and generate an output image that illustrates an undistorted representation of the scene. The MCU can identify variable-sized groupings of the lines of pixels in the input image and map each grouping to a memory range. In the example shown in aspect 700, the output image can be made up of 20 rows of blocks. For each row, the MCU can determine lines of pixels to be written to memory ranges in a local memory (e.g., a circular buffer), which can be accessed to produce the rows in the output image. Memory map 704 may be produced via process 600 or via any other suitable process.

In aspect 700 of FIG. 7A, input image location 705 includes start line 715, end line 720, next end line 725, and end line offset 730, which represent data of the input image mapped to block rows of the output image. Start line 715 and end line 720 refer to starting and ending locations/coordinates of a grouping of lines of pixels in the input image, respectively. Next end line 725 refers to the end location of a line of pixels corresponding to an immediately subsequent row, with respect to a current row, in the output image. For example, for block row 1 (under block row 710) in the output image, the MCU can assign a grouping of pixels corresponding to block row 1 addresses in a local memory starting from 94 (start line 715) and ending at 253 (end line 720). For block row 2 in the output image, the MCU can assign addresses 108 to 277. Next end line 725 of the first row is the same as end line 720 of the second row (277). End line offset 730 refers to the difference between the values of end line 720 and next end line 725. In this example, end line offset 730 for the first row is 24.

Each of the groupings of lines (lines between start line 715 to end line 720) and the end line offset 730 can vary in size for each of block row 710. The MCU can identify the number of lines for each of block row 710 based on how many lines are needed to process and produce a given block row. This may also be determined based on the context of the image and/or a capacity available of a memory. This means that each input image may lead to a different one of memory map 704 based on the context of the image.

Memory map 704 also includes information about the memory ranges in a local memory, shown as buffer location 735. Buffer location 735 includes start location 740, end location 745, size 750, next end location 755, and used buffer depth 760. Start location 740 refers to a starting address in the local memory. End location 745 refers to an ending address in the local memory. Size 750 refers to the buffer space required for a grouping of lines (i.e., start location 740 subtracted from end location 745). Next end location 755 refers to end location 745 corresponding to an immediately subsequent row, with respect to a current row, in the output image. Used buffer depth 760 refers to a total amount of memory required to store data associated with the grouping of lines and end line offset 730 corresponding to a respective row in the output image.

Components of an image processing system can use memory map 704 to perform write/read operations. A first write operation may include a vision imaging subsystem (e.g., VISS 325 of FIG. 3) writing a grouping of lines to memory. A read operation may include a remapping engine (e.g., LDC subsystem 335 of FIG. 3) reading the grouping of lines, or a subset of the grouping of lines, from memory to process and produce portions of the output image. By way of example, the grouping of lines in block row 1 (lines 94 to 253) can be written to addresses 0 (start location 740) to 159 (end location 745) in local memory. From block row 1 to block row 2, end line offset 730 is 24 lines, so those lines can also be included in the first write operation and can be written to addresses 160 to 183 (next end location 755). Accordingly, a write operation for block row 1 requires 183 spaces in local memory (used buffer depth 760). A first read operation of the grouping of lines in block row 1 may include only addresses 0-159, however. In this way, the VISS component can write additional lines (e.g., end line offset 730) to prevent stall between VISS operations and remapping engine operations. Following the previous example, a second write operation may include writing the data of block row 2 to memory. This includes writing lines 108 (start line 715 of block row 2) through lines 277 (end line 720) and further through line 307 (next end line 725) to addresses 14 (start location 740 of block row 2) through 213 (next end location 755 of block row 2). However, in various cases, the overlapping data from block row 1 to block row 2 need not be re-written to memory. The second read operation includes reading data from addresses 14 through 183 (end location 745 of block row 2), as those addresses hold the data for the second row block of the output image.

In various instances, the local memory is a circular buffer. The size of the circular buffer used for an image processing operation can be determined by a maximum amount of used buffer depth 760 for all the rows in the output image. In memory map 704, the maximum amount of used buffer depth 760 is 215 as seen in row 16 under block row 710. Thus, the allocation of the circular buffer may be set to 216 so that write operations do not exceed the capacity allocated. The addresses (e.g., start location 740 to end location 745) can be written to/read from in a circular nature meaning they can be overwritten after data is read from the addresses. For example, for block row 3 under block row 710, lines 132 (start line 715) to 307 (end line 720) can be assigned addresses 38 (start location 740) to 213 (end location 745). Additionally, the MCU can map 32 additional lines (end line offset 730) to the circular buffer, which means next end location 755 of block row 3 is 29 when the size of the circular buffer is 216.

In FIG. 7B, aspect 701 illustrates values associated with buffer location 735 and rows 1 and 2 of the output image from memory map 704. Aspect 702 demonstrates a graphical representation of a mapping of the values corresponding to row 1, while aspect 703 demonstrates a graphical representation of a mapping of the values corresponding to block row 2 in circular buffer 731. Aspects 702 and 703 refer to values depicted in the portion of memory map 704 in aspect 701.

In aspect 702, circular buffer 731 has 216 addresses to which an MCU can direct data to be written and read to and from, respectively. In this representation, the MCU can map a first grouping of lines of pixels of an input image to be written to addresses 0 (start location 740) to 159 (end location 745) of circular buffer 731. The MCU can also assign the additional lines of end line offset 730 addresses 160 to 183 (next end location 755). Accordingly, the MCU can provide a write instruction to a component to write data of the first grouping and the offset between the first grouping and the second grouping to addresses 0-183 (write location 765). The MCU can then provide a read instruction to a different component to read the data of the first grouping from addresses 0-159 (read location 770).

In aspect 703, the MCU can map a second grouping of lines of pixels to be written to addresses 14 (start location 740) to 183 (end location 745). Next end location 755 for block row 2 is 214. The MCU can assign end line offset 730 of block row 2 addresses 184 to 213. In this representation, because the write component already wrote pixel data from 0-183 (write location 760 of block row 1) in circular buffer 731, the MCU may direct writing of data only to addresses 184-213 (write location 765 of block row 2). In other words, the MCU may not require the write component to write overlapping data from the second grouping with respect to the first grouping. However, the MCU may still trigger the read component to read data from addresses 14-183 (read location 770), despite overlapping data from the first grouping, because block row 2 may utilize similar data as block row 1 to produce the second block row in the output image.

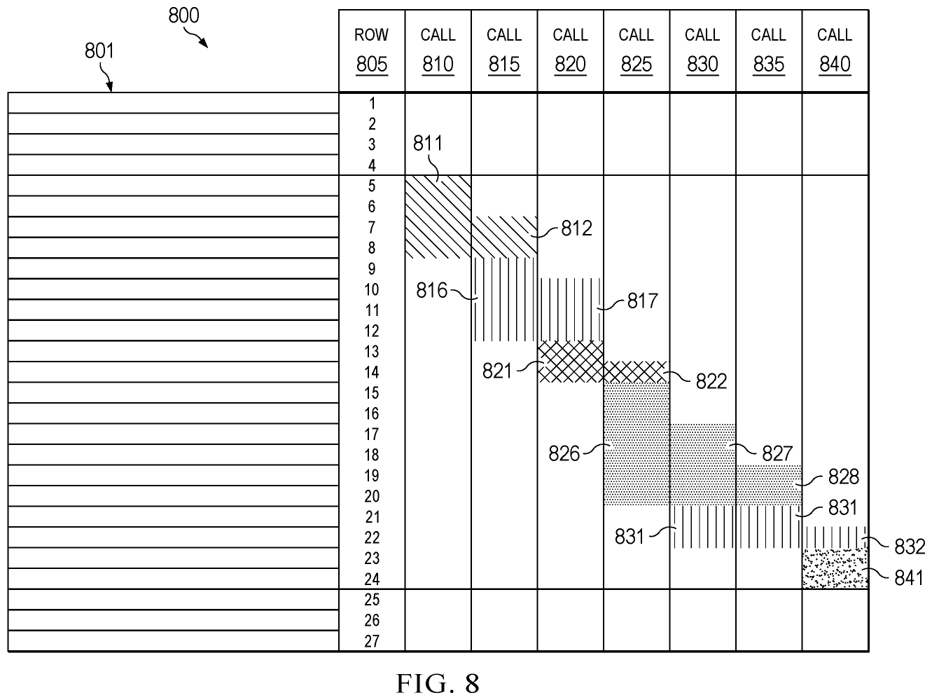

FIG. 8 illustrates an example graphical representation of selecting portions of an input image to create a memory map. FIG. 8 shows graphical representation 800, which includes input image 801 divided into sections. The sections of input image 801 can include lines of pixels organized into rows (row 805), and one or more rows of row 805 can be used to generate sections of an output image. Each of call 810, 815, 820, 825, 830, 835, and 840 can indicate how many rows of row 805 are to be used to produce the output image.

Input image 801 is representative of an image captured by an imaging system. Input image 801 can include a plurality of pixels arranged in lines that form a distorted representation of a scene. During image processing, components of an image processing subsystem can write pixel data of input image 801 into a local memory and read the pixel data from the local memory for processing into an output image to correct the distorted representation of the scene, among other functions. The output image includes the pixels of input image 801 in a different arrangement that form an undistorted representation of a scene. The output image can be arranged into row of blocks (or “block rows”), and each row can include lines of pixels of input image 801.

In graphical representation 800, row 805 refers to rows of lines of pixels in input image 801. In this example, input image 801 has 27 rows. Each row may include a plurality of pixels arranged in lines within a respective row. Calls 810, 815, 820, 825, 830, 835, and 840 (referred to collectively herein as “calls”) refer to read/write instructions provided by a scheduler component of an image processing subsystem (e.g., a thread scheduler, such as hardware thread scheduler 320 of FIG. 3). More specifically, each of the calls indicates a number of rows of input image 801 to be used to produce a block row of the output image during image processing and distortion correction. The scheduler component receives a mapping with each of the calls from a computing device or processor (e.g., processor 140 of FIG. 1 or processor 355 of FIG. 3) and can instruct components of the image processing subsystem based on the mapping. In this example, there are seven calls, each representative of the data required to produce a single block row (i.e., there are seven block rows formed from input image 801).

To generate the mapping, a computing device first identifies a context of input image 801. Context refers to properties of a lens used to capture input image 801, a perspective of input image 801 (from a user's point of view and/or from an imaging system's point of view), and several other factors. Using the context, the computing device can determine variable-sized groupings of lines of pixels of input image 801 (i.e., rows of pixels as illustrated in graphical representation 800) that can be used to produce the undistorted output image. In the mapping, the computing device assigns the variable-sized groupings to memory ranges in a local memory. The computing device also associates the groupings and memory ranges with a block row in the output image.

The scheduler component uses the mapping to instruct a write component of the image processing subsystem to write data in the rows of input image 801 to a range of memory addresses in the local memory. Subsequently, the scheduler component instructs a different component to read data from the memory addresses to produce blocks in block rows of the output image. In various cases, data can be retained from one call to a subsequent call. Such overlapping data, and an amount of overlap thereof, may be based on the context of input image 801. Further, some data from a subsequent call, with respect to a current call, can be added to the current call. This may be referred to as look-ahead or an offset from one call to a subsequent call. This may allow the write component to continue writing pixel data beyond the retained subset of pixel data while the read component finishes reading the pixel data from a previous call. Advantageously, this may allow for continuous writing and reading from the local memory until all pixel data from input image 801 has been written to and read from the local memory.

Call 810 includes pixel data 811, representative of pixel data of rows 5-8 of input image 801. The scheduler component can instruct the write component to write pixel data 811 to a memory. In some cases, the write component can write the data directly to a range of addresses within a memory according to a mapping. However, in other cases, the write component can write to one memory, or one portion of a memory, and a direct memory access component can place the data to specific memory locations. Subsequently, the scheduler component can instruct the read component to read pixel data 811 from the range of addresses to produce the blocks of the first block row of the output image. This process can be repeated for each call until all selected rows of input image 801 are mapped to memory ranges.

Call 815 includes pixel data 816, representative of pixel data in rows 9-12 of input image 801, and pixel data 812, representative of pixel data of rows 7-8 of input image 801 (i.e., a subset of pixel data 811 from call 810). Call 820 includes pixel data 821, representative of pixel data in rows 13-14 of input image 801, and pixel data 817, representative of pixel data of rows 10-12 of input image 801 (i.e., a subset of pixel data 816 from call 815). Call 825 includes pixel data 826, representative of pixel data in rows 15-20 of input image 801, and pixel data 822, representative of pixel data of row 14 of input image 801 (i.e., a subset of pixel data 821 from call 820). Call 830 includes pixel data 831, representative of pixel data in rows 21-22 of input image 801, and pixel data 827, representative of pixel data of row 17-20 of input image 801 (i.e., a subset of pixel data 826 from call 825). Call 835 includes pixel data 831 and pixel data 828, representative of pixel data of rows 19-20 of input image 801 (i.e., a subset of pixel data 826 and 827 from calls 825 and 830). Call 840 includes pixel data 841, representative of pixel data of rows 23-24 of input image 801, and pixel data 832, representative of pixel data of row 22 of input image 801 (i.e., a subset of pixel data 831 from calls 830 and 835).

In various examples, the scheduler component may not map some rows of input image 801 to block rows of the output image. Some rows may be excluded from the mapping, such as rows 1-4 and rows 25-27, for various reasons, such as lack of a need to correct distortion in the pixel data of the rows, or such as a lack of usefulness of the pixel data of the rows. In other cases, the computing device may generate a different mapping corresponding to a different variation or combination of rows of the output image and pixel data from input image 801. Thus, any combination or variation of pixel data can be used for any number of calls during image processing.

The calls demonstrated in FIG. 8 can make up a mapping for memory management techniques described herein. For example, each call can indicate an amount of data, and which data, required to produce an output image based on the context of the input image. From the map, a decrement amount can also be determined from call to call. This refers to a number of lines not needed from one call to the next call. For example, from call 810 to call 815, rows 5-7 of input image 801 is no longer needed, so the data of rows 5-7 can be decremented and removed from memory.

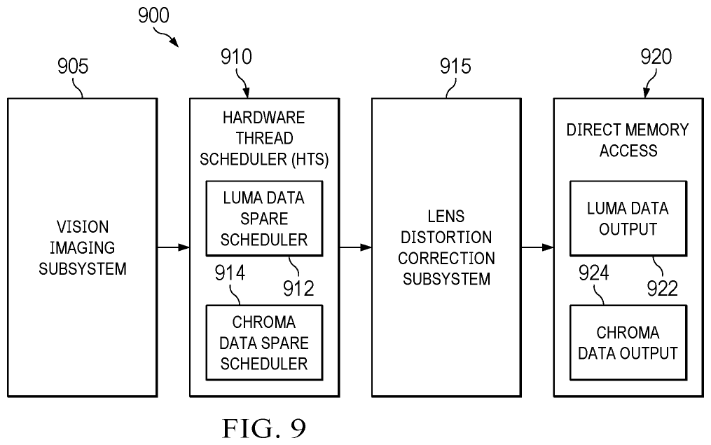

FIG. 9 illustrates an example operating environment for processing multiple types of pixel data in distortion correction processes. FIG. 9 includes operating environment 900, which further includes vision imaging subsystem (VISS) 905, hardware thread scheduler (HTS) 910, lens distortion correction (LDC) subsystem 915, and direct memory access 920.

VISS 905 represents an image pipeline component configured to perform pre-processing tasks, such as converting raw pixel data into processed pixel data, on image data of an image captured by an imaging system (not shown). For example, VISS 905 may be configured to receive raw pixel data of an image captured by an imaging system. VISS 905 can generate a full frame from the image with processed pixel data. The full frame may include luma data and chroma data related to the processed pixels.

HTS 910 represents a fixed-purpose thread scheduler configured to direct LDC subsystem 915, among other components of an image processing system, to process pixel data. HTS 910 can include luma data spare scheduler 912, which can direct the components with respect to luma pixel data, and chroma data spare scheduler 914, which can direct the components with respect to chroma pixel data. In various examples, HTS 910 instructs LDC subsystem 915, according to a mapping (e.g., a memory-mapped register), to read pixel data from a memory to process the pixel data and produce corrected pixel data for use in an output frame that shows an undistorted representation of a scene. The mapping can include correlations between various memory ranges of a local memory to an image processing system (neither shown here) and the processed pixel data from VISS 905.

LDC subsystem 915 operates per instructions from HTS 910. LDC subsystem 915 can process both luma data and chroma data according to the instructions given by both luma data spare scheduler 912 and chroma data spare scheduler 914. Upon generating the corrected output frame, LDC subsystem 915 can provide the output frame to direct memory access 920. In various cases, LDC subsystem 915 provides the output frame in chunks (e.g., blocks).

Direct memory access 920 includes luma data output 922 and chroma data output 924. Direct memory 920 may be configured to provide pixel data from the output frame, such as luma data and chroma data, to downstream subsystems, devices, and peripherals. Specifically, luma data output 922 can communicate luma data of the output frame downstream and chroma data output 924 can communicate chroma data of the output data downstream.

While some examples provided herein are described in the context of an imaging system, image processing system or subsystem, architecture, or environment, the distortion correction system, devices, and methods described herein are not limited to such embodiments and may apply to a variety of other processes, systems, applications, devices, and the like. Aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising.” and the like are inclusive meaning “including, but not limited to.” In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A. A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or.” in reference to a list of two or more items, covers all of the following interpretations of the word: any of the items in the list, all of the items in the list, and any combination of the items in the list.

The phrases “in some embodiments,” “according to some embodiments,” “in the embodiments shown.” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method, comprising:
identifying a context of an image captured by an imaging system, wherein the image comprises lines of pixels that form a distorted representation of a scene;
identifying, based on the context of the image, a mapping of variable-sized groupings of the lines to memory ranges in a buffer, wherein an image processing subsystem produces block rows of an output image based on the mapping, and wherein a size of each of the variable-sized groupings varies based on how many of the lines the image processing subsystem uses to produce each of the block rows; and
supplying the mapping to the image processing subsystem.

2. The method of claim 1, wherein the mapping further comprises correlations between the block rows of the output image and corresponding ones of the memory ranges in the buffer.

3. The method of claim 2, wherein the block rows of the output image form an undistorted representation of the scene.

4. The method of claim 2, wherein the image processing subsystem comprises an image pre-processing component configured to write pixel data of the variable-sized groupings to the memory ranges in the buffer and a lens distortion correction component configured to read the pixel data from the memory ranges to produce the block rows of the output image.

5. The method of claim 4, further comprising instructing the image pre-processing component to write the pixel data to the corresponding memory ranges.

6. The method of claim 5, further comprising instructing the lens distortion correction component to read the pixel data from the corresponding memory ranges to produce the block rows of the output image.

7. The method of claim 1, wherein the context of the image comprises one or more of properties of a lens that captured the image, a perspective of the image, and a resolution of the image.

8. One or more computer-readable storage media having program instructions stored thereon for mapping image data to memory ranges of a buffer, wherein the program instructions, when read and executed by a processing system, direct the processing system to:
identify a context of an image captured by an imaging system, wherein the image comprises lines of pixels that form a distorted representation of a scene;
identify, based on the context of the image, a mapping of variable-sized groupings of the lines to the memory ranges in the buffer, wherein an image processing subsystem produces block rows of an output image based on the mapping, and wherein a size of each of the variable-sized groupings varies based on how many of the lines the image processing subsystem uses to produce each of the block rows; and
supply the mapping to the image processing subsystem.

9. The one or more computer-readable storage media of claim 8, wherein the mapping further comprises correlations between the block rows of the output image and corresponding ones of the memory ranges in the buffer.

10. The one or more computer-readable storage media of claim 9, wherein the block rows of the output image form an undistorted representation of the scene.

11. The one or more computer-readable storage media of claim 9, wherein the image processing subsystem comprises an image pre-processing component configured to write pixel data of the variable-sized groupings to the memory ranges in the buffer and a lens distortion correction component configured to read the pixel data from the memory ranges to produce the block rows of the output image.

12. The one or more computer-readable storage media of claim 11, wherein the program instructions further direct the processing system to instruct the image pre-processing component to write the pixel data to the corresponding memory ranges.

13. The one or more computer-readable storage media of claim 12, wherein the program instructions further direct the processing system to instruct the lens distortion correction component to read the pixel data from the corresponding memory ranges to produce the block rows of the output image.

14. The one or more computer-readable storage media of claim 8, wherein the context of the image comprises one or more of properties of a lens that captured the image, a perspective of the image, and a resolution of the image.

15. A system, comprising:
a processor in communication with an image processing subsystem, wherein the processor is configured to:
identify a context of an input image captured by an imaging system, wherein the input image comprises lines of pixels that form a distorted representation of a scene;
identify, based on the context of the image, a mapping of variable-sized groupings of the lines to memory ranges in a buffer, wherein a size of each of the variable-sized groupings varies based on how many of the lines the image processing subsystem uses to produce each block row of an output image based on the mapping; and
supply the mapping to the image processing subsystem; and
the image processing subsystem comprising a pre-processing component and a lens distortion correction component, wherein the image processing subsystem is configured to:
receive the mapping from the processor;
instruct the pre-processing component to write the variable-sized groupings of the image to corresponding ones of the memory ranges in the buffer; and
instruct the lens distortion correction component to read the variable-sized groupings from the corresponding ones of the memory ranges to produce the block rows of the output image.

16. The system of claim 15, wherein the mapping further comprises correlations between the block rows of the output image and corresponding ones of the memory ranges in the buffer.

17. The system of claim 15, wherein the block rows of the output image form an undistorted representation of the scene.

18. The system of claim 15, wherein the context of the image comprises one or more of properties of a lens that captured the image, a perspective of the image, and a resolution of the image.

19. The system of claim 15, wherein the variable-sized groupings comprise a first subset of the lines of the pixels corresponding to a first block row of the output image and a second subset of the lines of the pixels corresponding to a second block row of the output image.

20. The system of claim 19, wherein a size of the first subset of the lines and a size of the second subset of the lines each vary based further on an available capacity of the buffer.
